(19) United States
(12) Patent Application Publication
(10) Pub. No.: US 2023/0125356 A1
(43) Pub. Date: Apr. 27, 2023

(54) Zoom Lens Assembly with Flat Coil Extension Spring Termination

(71) Applicant: Ophir Optronics Solutions Ltd., Jerusalem (IL)

(72) Inventor: Nahum Ahituv, Jerusalem (IL)

(73) Assignee: Ophir Optronics Solutions Ltd., Jerusalem (IL)

(21) Appl. No.: 17/510,119

(22) Filed: Oct. 25, 2021

(51) Int. Cl. G02B 1/14; F16F 1/12; G02B 7/10; G02B 15/04

(52) U.S. Cl. CPC G02B 1/14; F16F 1/125; G02B 7/102; G02B 15/04

(57) ABSTRACT

The present application discloses a zoom lens assembly utilizing a novel extension spring configured to exert a biasing force on one or more lens cells during operation thereof. In one embodiment, the extension spring includes a spring body having a coil axis, a first spring end region having a first inner coil and a first outer coil formed on the spring body, wherein the coil axis of the spring body transitions from the first inner coil to the first outer coil. The extension spring further includes a second spring end region having a second inner coil and a second outer coil formed on the spring body, wherein the coil axis of the spring body transitions from the second inner coil to the second outer coil. An intermediate spring region having a plurality of intermediate coils extends from the first spring end region to the second spring end region.

### BACKGROUND

Zoom lenses are used for a variety of applications, such aerospace and military imaging, thermal imaging, inspection, in a variety of wavelengths, from UV to infrared. In some applications, especially airborne applications, size and weight of the zoom lens assembly are important design parameters. For example, for military applications such as unmanned aerial vehicles and missiles, the size and weight of the zoom lenses should be minimized.

While prior art zoom lens assemblies have proven useful in the past, a number of shortcomings have been identified. For example, extension springs known in the art that are used to eliminate backlash between various lens cells within a zoom lens assembly have hooked or looped spring terminations that are bulky and subject to fatigue failures.

In light of the foregoing, there is an ongoing need for an improved extension spring termination design that reduces overall spring length and has a longer fatigue life.

### SUMMARY

The present application discloses an extension spring. In one embodiment, the extension spring comprises has at least one spring body having at least one coil axis, at least one first spring end region having at least one first inner coil and at least one first outer coil, wherein the coil axis of the spring body transitions from the first inner coil to the first outer coil. The extension spring further comprises at least one second spring end region having at least one second inner coil and at least one second outer coil formed on the at least one spring body, wherein the at least one coil axis of the at least one spring body transitions from the at least one second inner coil to the at least one second outer coil. The extension spring further comprises at least one intermediate spring region including a plurality of intermediate coils formed on the at least one spring body, the at least one intermediate spring region extending from the at least one first spring end region to the at least one second spring end region.

In another embodiment, the extension spring comprises has at least one spring body having at least one coil axis, at least one first spring end region having at least one first inner coil and at least one first outer coil formed on the spring body wherein the at least one coil axis of the spring body transitions from the at least one first inner coil to the first outer coil and the first inner coil has at least one coil radius smaller than at least one coil radius of the first outer coil. The extension spring further comprises at least one second spring end region having at least one second inner coil and at least one second outer coil formed on the spring body, wherein at least one coil axis of the spring body transitions from the second inner coil to the second outer coil. The extension spring further comprises at least one intermediate spring region including a plurality of intermediate coils formed on the spring body, the intermediate spring region extending from the first spring end region to the second spring end region.

In another embodiment, the extension spring includes at least one spring body having at least one coil axis, at least one first spring end region having one or more first inner coils formed on the spring body, at least one second spring end region including one or more second outer coils formed on the spring body, at least one intermediate spring region including a plurality of intermediate coils arranged helically around at least one spring axis, the intermediate coils extending from the first spring end region and the at least one second spring end region. At least one of the first inner coils has a coil radius smaller than the coil radius of at least one of the intermediate coils, and at least one of the second outer coils has a coil radius larger than the coil radius of at least one of the intermediate coils.

The present application also discloses a lens assembly. In one embodiment, the lens assembly comprises at least one lens support, at least one extension spring, at least one structure or flange secured to at least one end of the lens support body, and at least one lens cell. The lens support body includes at least one optical axis, the lens support body sized to receive the lens cell therein. The structure or flange is secured to at least one end of the lens support body, the flange having at least one flange body with at least one spring support recess formed therein, the spring support recess sized to receive at least one of the first spring end region or the second spring end region, the spring support recess further including having at least one support surface formed therein, the support surface configured to support at least one of the first spring end region or the second spring end region. The lens cell includes at least one lens cell body having at least one spring recess formed therein, the at least one spring recess sized to receive at least one of the first spring end region or the second spring end region, and at least one retention member including at least one first retention member body configured to engage and retain at least one of the first spring end region or the second spring end region within the at least one spring recess.

In another embodiment, the lens assembly includes at least one lens support body having at least one first end and at least one second end, at least one optical component coupled to the first end of the lens support body, at least one flange or structure coupled to the second end of the lens support body, the flange having one or more spring support recesses formed therein, and one or more extension springs configured to exert at least one biasing force to urge the lens cell toward the flange. The extension spring further comprises at least one spring body having at least one coil radius, at least one first spring end region having one or more first inner coils formed on the at least one spring body, at least one second spring end region including one or more second outer coils formed on spring body, and at least one intermediate spring region including a plurality of intermediate coils having at least one coil radius. The intermediate coils are arranged helically around at least one spring axis and extend from the first spring end region to the second spring end region. The first inner coil has at least one coil radius smaller than the coil radius of at least one of the intermediate coils, and the second outer coil has at least one coil radius larger than at least one coil radius of the intermediate coil radius.

### BRIEF DESCRIPTION OF THE DRAWINGS

Various embodiments of an improved zoom lens assembly will be explained in more detail by way of the accompanying drawings, wherein:

FIG. 1 shows an exterior view of an embodiment of a zoom lens assembly;

FIG. 2 shows a cross-sectional view of the embodiment of a zoom lens assembly shown in FIG. 1;

FIG. 3 shows a cross-sectional view of the embodiment of the zoom lens assembly shown in FIG. 1;

FIG. 4 shows a cross-sectional view of the embodiment of the zoom lens assembly shown in FIG. 1;

FIGS. 5 and 6 show various cross-sectional views of an embodiment of an extension spring with flat coil termination for use with the zoom lens assembly shown in FIGS. 1-4;

FIGS. 7 and 8 show various cross-sectional views of an alternate embodiment of an extension spring with flat coil termination for use with the zoom lens assembly shown in FIGS. 1-4; and

FIGS. 9 and 10 show various cross-sectional views of an alternate embodiment of an extension spring with flat coil termination for use with the zoom lens assembly shown in FIGS. 1-4.

### DETAILED DESCRIPTION

Example embodiments are described herein with reference to the accompanying drawings. Unless otherwise expressly stated, in the drawings the sizes, positions, etc., of components, features, elements, etc., as well as any distances therebetween, are not necessarily to scale, but are exaggerated for clarity. In the drawings, like numbers refer to like elements throughout. Thus, the same or similar numbers may be described with reference to other drawings even if they are neither mentioned nor described in the corresponding drawing. Also, even elements that are not denoted by reference numbers may be described with reference to other drawings.

The terminology used herein is for the purpose of describing particular exemplary embodiments only and is not intended to be limiting. Unless otherwise defined, all terms (including technical and scientific terms) used herein have the same meaning as commonly understood by one of ordinary skill in the art. As used herein, the singular forms “a,” “an” and “the” are intended to include the plural forms as well, unless the context clearly indicates otherwise. It should be recognized that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. Unless indicated otherwise, terms such as “first,” “second,” etc., are only used to distinguish one element from another. For example, one coupler could be termed a “first coupler” and similarly, another node could be termed a “second coupler”, or vice versa.

Unless indicated otherwise, spatially relative terms, such as “below,” “beneath,” “lower,” “above,” and “upper,” “opposing,” and the like, may be used herein for ease of description to describe one element or feature's relationship to another element or feature, as illustrated in the FIGS. It should be recognized that the spatially relative terms are intended to encompass different orientations in addition to the orientation depicted in the FIGS. For example, if an object in the FIGS. is turned over, elements described as “below” or “beneath” other elements or features would then be oriented “above” the other elements or features. Thus, the exemplary term “below” can encompass both an orientation of above and below. An object may be otherwise oriented (e.g., rotated 90 degrees or at other orientations) and the spatially relative descriptors used herein may be interpreted accordingly.

The paragraph numbers used herein are for organizational purposes only and, unless explicitly stated otherwise, are not to be construed as limiting the subject matter described. It will be appreciated that many different forms, embodiments and combinations are possible without deviating from the spirit and teachings of this disclosure and so this disclosure should not be construed as limited to the example embodiments set forth herein. Rather, these examples and embodiments are provided so that this disclosure will be thorough and complete, and will convey the scope of the disclosure to those skilled in the art.

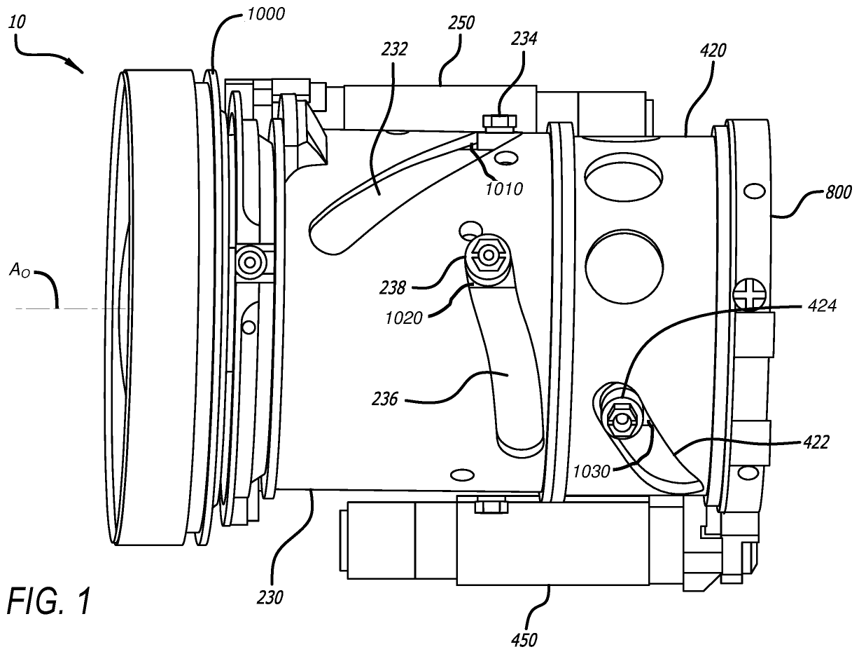

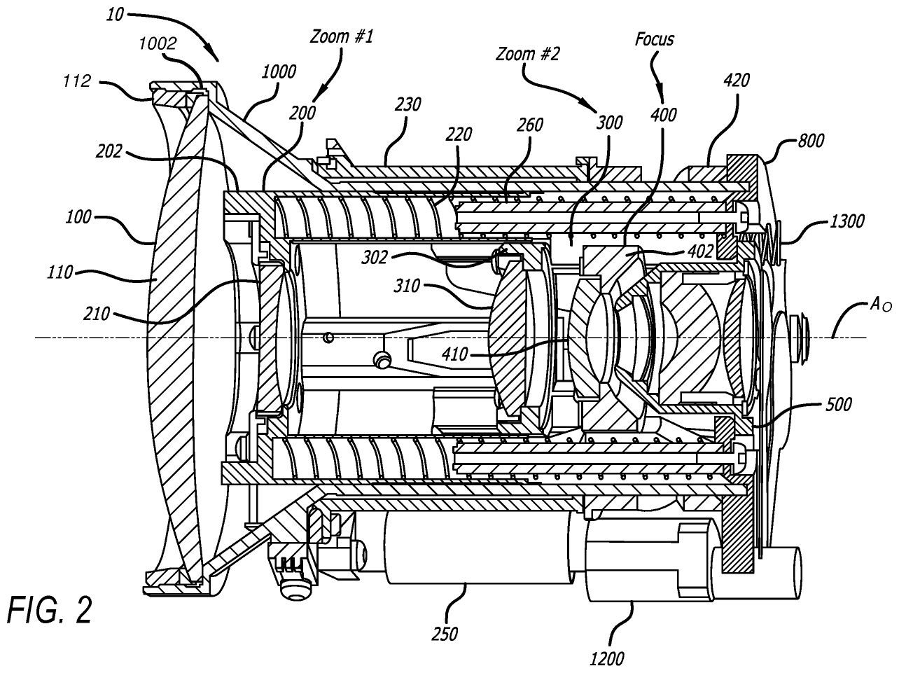

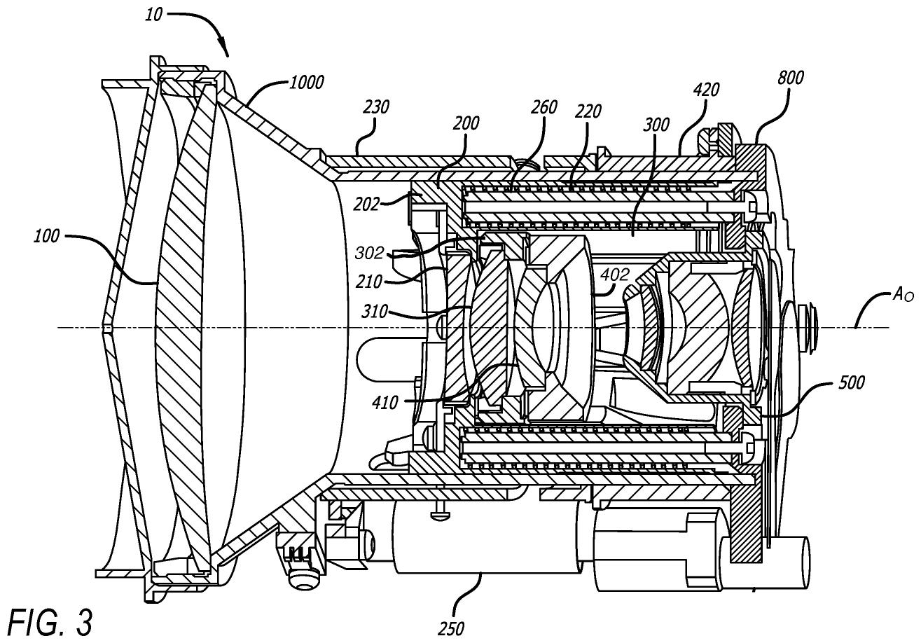

FIGS. 1-3 show exterior and cross-sectional views of an exemplary embodiment of a zoom lens assembly 10, respectively. In the illustrated embodiment, as shown in FIGS. 2 and 3, the zoom lens assembly 10 includes five lens cells, a first lens cell 100, a second lens cell 200, a third lens cell 300, a fourth lens cell 400, and a fifth lens cell 500 coaxially aligned to an optical axis A_{O}. In this embodiment, the first lens cell 100 performs magnification, the second lens cell 200 and the third lens cell 300 perform zoom functions, the lens cell 400 performs a focus function, and the fifth lens cell 500 relays the optical image to an optical sensor (not shown). In this embodiment, the first lens cells 100 and the fifth lens cell 500 are fixed relative to each other. Those skilled in the art will appreciate the zoom lens assembly 10 may include any number of lens cells performing any variety of functions. During operation of the zoom lens assembly 10, the lens cells 200, 300 and 400 undergo reciprocating motion along the optical axis A_{O} to perform the zoom and focus functions of the zoom lens assembly 10 (e.g., in response to control commands given by a control system or system operator).

Referring to FIG. 1, the zoom lens assembly 10 includes at least one lens support body 1000 (also referred to herein as the “support body 1000”) configured to contain the lens cells 100-500 (shown in FIGS. 2 and 3) therein. The support body 1000 includes a plurality of support body slots 1010, 1020, and 1030 formed therein, with each support body slot configured to accept at least one cam follower used to change the position of the lens cells 200, 300 and 400 along an optical axis A_{O}. At least one first cam actuator 250 configured to rotate a first cam 230 is mounted on a first end of the support body 1000. At least one flange 800 is secured to the second end of the support body 1000. At least one second cam actuator 450 configured to rotate at least one second cam 420 with respect to the support body 1000 is mounted on the flange 800. The first cam 230 and the second cam 420 are positioned coaxially with the support body 1000 around the optical axis A_{O}. At least one first cam slot 232 formed helically around the optical axis A_{O} and sized to receive a first cam follower 234 is formed in the first cam 230. The first cam follower 234 is attached to the second lens cell 200, and extends through both the first support body slot 1010 and the first cam slot 232, and engages the sides of the cam slot 232, so that when the first cam 230 is rotated relative to the support body 1000 by the first cam actuator 250, the position of the second lens cell 200 is changed along the optical axis A_{O}.

At least one second cam slot 236 sized to receive a second cam follower 238 is also formed in the first cam 230. The second cam follower 238 is attached to the third lens cell 300, and extends through both the second support body slot 1020 and the second cam 236, and is operative to engage the sides of the second cam slot 236 so that when the first cam 230 is rotated by the first cam actuator 250 relative to the support body 1000, the position of the third lens cell 300 is changed along the optical axis A_{O}. The second cam 420 is positioned coaxially with the support body 1000 around the optical axis A_{O} between the first cam 230 and the flange 800. At least one third cam slot 422 formed helically around the optical axis A_{O} and sized to receive a third cam follower 424 therein is formed in the second cam 420. The third cam follower 424 is attached to the third lens cell 300, and extends through both the third support body slot 1030 and the third cam slot 422, and is operative to engage the sides of the third cam slot 422 so that when the second cam 420 is rotated by the second cam actuator 450 relative to the support body 1000, the position of the fourth lens cell 400 is changed along the optical axis A_{O}.

As shown in FIG. 2, in the illustrated embodiment, the first lens cell 100 includes a single optical component 110 provided as a convex-concave lens, but those skilled in the art will appreciate that the first lens cell 100 may have any number or variety of optical components. At least one retention recess 1002 sized to receive the first lens cell 100 therein is formed in a first end of the support body 1000. At least one retention member 112 configured to securely retain the optical component 110 is also positioned in the retention recess 1002.

FIGS. 2 and 3 show cross-sectional views of the zoom lens assembly 10 with the lens cells 200, 300 and 400 in a combination of extended or retracted positions, relative to the flange 800. FIG. 2 shows the second lens cell 200 in an extended position, and the third and fourth lens cells 300, 400 in a retracted position, along the optical axis A_{O}. FIG. 3 shows the second lens cell 200 in a retracted position, and the third and fourth lens cells 300, 400 in an extended position, along the optical axis A_{O}.

In the illustrated embodiment, the second lens cell 200 includes at least one second lens cell body 202 configured to receive and retain at least one optical component 210 therein. In this embodiment, the optical component 210 is a plano-concave lens. Those skilled in the art will appreciate that the second lens cell 200 may have any number or variety of optical components. At least one recess 204 sized to receive at least one compression spring 220 therein is formed in the second lens cell body 202. One end of the compression spring 220 is secured to the flange 800, so that when the position of the second lens cell 200 is changed along the optical axis A_{O}, the compression spring 220 exerts a biasing force on the second lens cell body 202 such that the first cam follower 234 bears on the walls of the cam slot 232, thereby reducing or eliminating hysteresis or backlash in the position of the second lens cell 200 during the reciprocating motion of the second lens cell 200 along the optical axis A_{O} during operation of the zoom lens assembly 10. A spring bushing 260 may be positioned inside of the coils of the compression spring 220 to guide the coils of the compression spring 220 and prevent buckling (e.g., the tendency of a compression spring to bow or to deflect laterally when loaded) of the compression spring 220.

In the illustrated embodiment, the third lens cell 300 includes at least one third lens cell body 302 configured to receive and retain at least one optical component 310 therein. In this embodiment, the optical component 310 is a single plano-convex lens. Those skilled in the art will appreciate that the third lens cell 300 may have any number or variety of optical components. In the illustrated embodiment, the fourth lens cell 400 includes at least one fourth lens cell body 402 configured to receive and retain at least one optical component 410 therein. In this embodiment, the optical component 410 is a single convex-concave lens. Those skilled in the art will appreciate that the fourth lens cell 400 may have any number or variety of optical components.

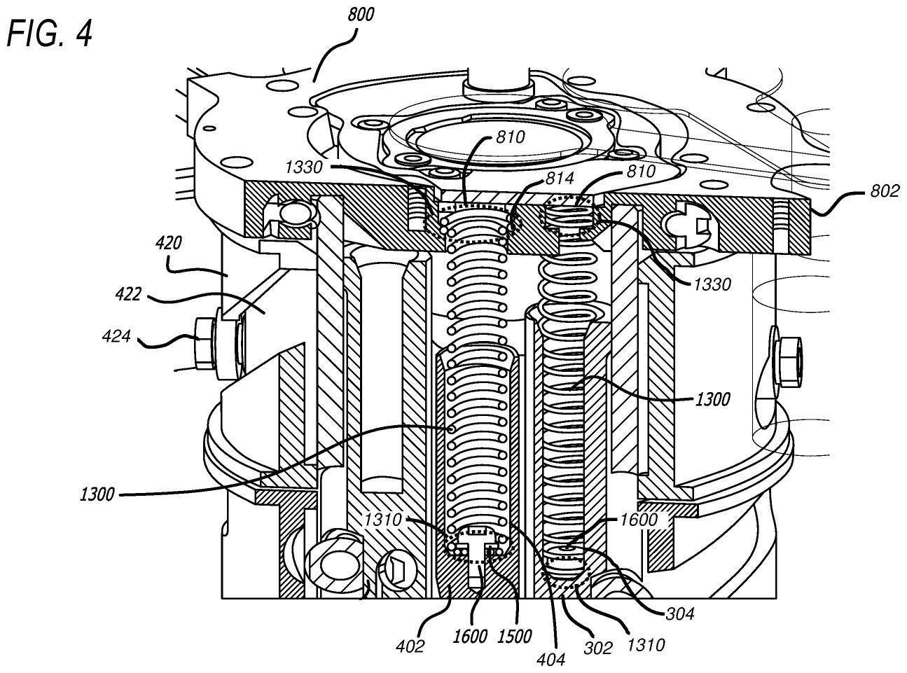

FIG. 4 shows a close-up cross-sectional view of the embodiment of the zoom lens assembly 10 detailing the connections between an extension spring 1300 configured to exert a biasing force on elements of the fourth lens cell 400 and the flange 800 during operation of the zoom lens assembly 10. The fourth lens cell body 402 also has one or more spring recesses 404 formed therein, each of the spring recesses 404 being sized to receive the extension spring 1300 therein. In the illustrated embodiment, the extension spring 1300 has at least one first spring end region 1310 and at least one second spring end region 1330. The first spring end region 1310 of spring 1300 is retained within the spring recess 404 by at least one retention member 1500 configured to engage the coils of the first spring end region 1310, and at least one coupler or fastener 1600 configured to engage the retention member 1500 and securely fasten it to the fourth lens cell body 402. As shown, one or more spring support recesses 810 are formed in the flange body 802, with each spring support recess 810 including at least one support surface 814 configured to engage the second spring end region 1330 and retain it therein. During operation, when the second cam actuator 450 rotates the second cam 420, third cam follower 424 engages the third cam slot 422, extending or retracting the fourth lens cell 400 along the optical axis A_{O}, the spring 1300 exerts a biasing force urging the fourth lens cell toward the flange 800.

FIG. 4 also shows the third lens cell body 302 with at least one spring recess 304 formed therein, the spring recesses 304 being sized to receive at least one extension spring 1300 therein. In similar fashion to the fourth lens cell body 402 described above, in the illustrated embodiment, the extension spring 1300 has a first spring end region 1310 and a second spring end region 1330. The first spring end region 1310 of spring 1300 is retained within the spring recess 304 by at least one retention member (not shown) configured to engage the coils of the first spring end region 1310, and at least one coupler or fastener 1600 configured to engage the retention member and securely fasten it to the third lens cell body 302. The second spring end region 1330 is positioned within a spring support recess 810 formed in the flange body 802, with the coils of the second spring end region 1330 engaging the support surface 814. During operation of the zoom lens assembly 10, referring to FIG. 1, when the first cam actuator 250 rotates the first cam 230, the second cam follower 238 engages the second cam slot 236, extending or retracting the third lens cell 300 along the optical axis A_{O}, the spring 1300 exerts a biasing force urging the third lens cell 300 toward the flange 800.

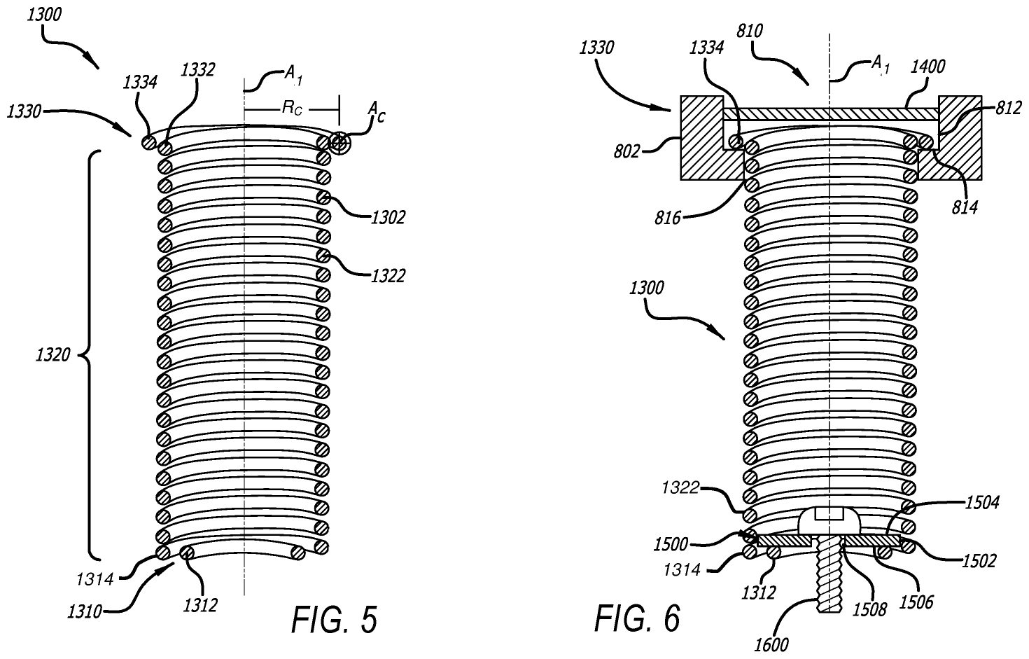

FIGS. 5-10 show various views of embodiments of extension coil springs configured to provide biasing forces between the various lens cells and the structure of the zoom lens assembly 10 to reduce or eliminate hysteresis or backlash in the position of the lens cells during their reciprocating motion along the optical axis A_{O} during operation. As is known in the art, in extension coil springs, the material of the spring reacts in torsion when the spring is being extended, thereby generating a biasing or restoring force between the ends of the spring. The following paragraphs of this disclosure rely on some terminology known in the art and used in the design and manufacture of extension coil springs. For example, the term “spring axis” (herein referred to as A₁) is the axis around which the spring coils are wound. The term “wire diameter”, is the measurement of the round wire thickness of which a spring is made of. The term “inner coil diameter” refers to the measurement of the inside of the coil from side to side (e.g., transverse to the spring axis A₁). The term “hourglass spring” refers to a spring that has coil diameters become gradually larger toward the spring ends, thus giving it an hourglass or concave shape.

Other terms used herein are specifically defined for this disclosure to best describe the novel features of the invention. In some embodiments, the cross-section of the spring wire may be square or rectangular, so the term “wire cross section” may be used to describe the square or rectangular dimensions of the spring wire. For example, the term “coil axis” A_{C} used herein is the axis of the spring body, centered on the wire diameter. Another term used in this disclosure is “coil radius”, R_{C}, which is the distance measured from the spring axis A₁ to the coil axis A_{C}.

As is known in the art, the force Fₛ needed to extend or compress a spring by some distance x (according to Hooke's law) scales linearly with respect to that distance, that is, Fₛ=kx, where k is a constant factor characteristic of the spring, and x is small compared to the total possible deformation.

The springs described below are generally provided as extension coil springs having a first spring end region, an intermediate spring region and a second spring end region. For example, with respect to FIG. 5, the extension spring 1300 (also referred to herein as the “spring 1300”) includes a first spring end region 1310, an intermediate spring region 1320 and a second spring end region 1330. In this embodiment, the spring 1300 has straight shape (e.g., wherein the coil radius R_{C} of the coils in the intermediate spring region is substantially constant). In another embodiment (though not shown), the extension spring may be provided as an hourglass spring, wherein the coil radius R_{C} of the spring coils is gradually reduced toward the center of the intermediate spring region, then is gradually increased toward the second spring end region. In another embodiment, the extension spring 1300 may be provided as a tapered or conical spring, wherein the coil radius in the intermediate spring region progressively increases between the first spring end region and the second spring end region.

As is known in the art, extension springs may have looped or hooked terminations, where a loop or hook is formed as one or more spring coils (or a portion of a spring coil) formed at about 90 degrees with respect to the other spring coils. These loop or hook terminations are configured receive screws, bolts, or pins extending therethrough that connect the ends of the spring to the structures of the assemblies the springs are used in. The Detailed Description below discloses various spring embodiments that use a “flat” coil termination design having one or more “flat” coils formed at one or more ends of the spring (e.g., formed as a coil oriented partially or substantially parallel to the other spring coils (roughly perpendicular to the spring axis A₁).

FIGS. 5 and 6 show various views of an embodiment of the extension spring 1300 shown in the FIG. 4. As shown in FIG. 5, in the illustrated embodiment, the spring 1300 includes a first spring end region 1310, an intermediate spring region 1320, and a second spring end region 1330. In this embodiment, the spring 1300 includes a spring body 1302 having a coil axis A_{C}, wound helically around a spring axis A₁. The first spring end region 1310 includes a first inner coil 1312 and a first outer coil 1314 formed in the spring body 1302, wherein the first inner coil 1312 has a coil radius R_{C} smaller with respect to the spring axis A₁ than the coil radius R_{C} of the first outer coil 1314 and the intermediate coils 1322. In the illustrated embodiment, the intermediate spring region 1320 includes a plurality of intermediate coils 1322 formed on the spring body 1302 and wound helically around the spring axis A₁, the intermediate spring region 1320 extending from the first spring end region 1310 to the second spring end region 1330. The second spring end region 1330 includes at least one second inner coil 1332 and at least one second outer coil 1334 formed in the spring body 1302. In this embodiment, the second outer coil 1334 has a larger coil radius R_{C} than the intermediate coils 1322 and the second inner coil 1332.

In the illustrated embodiment, the spring body 1302 is formed from cold drawn high carbon steel general-purpose wire. Optionally, the spring body 1302 may be formed from a variety of spring materials known in the art, such as high strength steels (e.g., music wire, oil tempered MB, hard drawn MB and the like), stainless steels (e.g., 302, 304, 316, precipitation hardened 17-4 PH, and the like), alloy steels (e.g., chrome vanadium, chrome silicon and the like), nickel alloys (e.g., Hastelloy, NiSpanC, Elgiloy, Inconel, and the like), or shape memory alloys (e.g., nickel-titanium, copper-nickel-titanium, and the like). Those skilled in the art will appreciate that the spring body 1302 may be formed of any variety of materials.

In the illustrated embodiment, the spring body 1302 transitions from the first spring end region 1310 to the intermediate spring region 1320. In this transition, the coil radius R_{C} of the spring body 1302 increases as spring body 1302 transitions along the coil axis A_{C} from the first inner coil 1312 to the first outer coil 1314 and to the intermediate coils 1322 in the intermediate spring region 1320. In one embodiment, the first inner coil 1312 and the first outer coil 1314 are arranged substantially coplanar. In another embodiment, the first inner coil 1312 and the first outer coil 1314 are not arranged substantially coplanar. Optionally, at least a portion of the first inner coil 1312 and at least a portion the first outer coil 1314 are arranged coplanar or approximately coplanar.

In the illustrated embodiment, the spring body 1302 transitions from the intermediate spring region 1320 to the second spring end region 1330. In this transition, the coil radius R_{C} of the spring body 1302 increases as the spring body 1302 transitions along the coil axis A_{C} from an intermediate coil 1322 to the second inner coil 1332. The coil radius R_{C} of the spring body 1302 increases as the spring body 1302 transitions from the second inner coil 1332 to the second outer coil 1334. In one embodiment, the second inner coil 1332 and the second outer coil 1334 are arranged substantially coplanar. In another embodiment, the second inner coil 1332 and the second outer coil 1334 are not arranged substantially coplanar. Optionally, at least a portion of the second inner coil 1332 and at least a portion of the second outer coil 1334 are coplanar or approximately coplanar.

Referring to FIG. 6, when the extension spring 1300 is installed into a structure (e.g., such as the flange 800 of the zoom lens assembly 10), the first spring end region 1310 may be securely retained in a spring recess formed in one of the lens cell bodies (e.g., such as the spring recess 404 formed in the fourth lens cell body 402 as shown in FIG. 4). In one embodiment, at least one retention member 1500 may be provided that engages the first spring end region 1310, the retention member 1500 having a retention member body 1502 having a first retention surface 1504 and a second retention surface 1506 with a passage 1508 formed therein, the passage 1508 configured to allow a coupler or fastener 1600 to traverse therethrough. The second retention surface 1506 engages the first inner coil 1312 to securely retain the first inner coil 1312 within the spring recess 404 formed in the fourth lens cell body 402 (e.g., as shown in FIG. 4). In an alternate embodiment, no retention member 1500 may be provided, and the coupler or fastener 1600 may engage the first inner coil 1312 directly, to securely retain the first inner coil 1312 within the spring recess 404.

FIG. 6 also shows a view of a portion of the flange body 802. In this embodiment, as shown, at least one spring support recess 810 configured to accept and retain the second spring end region 1330 therein is formed in the flange body 802. The spring support recess 810 includes at least one inner diameter 812 and at least one support surface 814 configured to engage the second outer coil 1334 of the second spring end region 1330. When installed in the zoom lens assembly 10, the extension spring 1300 extends through a passage 816 formed in the flange body 802. In the illustrated embodiment, at least one retention member 1400 may be inserted into the spring support recess 810 to retain the second spring end region 1330 within the spring support recess 810. Examples of the retention member 1400 include, without limitation, washers, plugs, snap rings, set screws, and the like or any combination thereof. Optionally, no retention member 1400 may be used.

During use, when the extension spring 1300 undergoes extension, (e.g., when one of the third lens cell 300 or the fourth lens cell 400 undergoes a change in position along the optical axis A_{O} relative to the flange body 802), in the first spring end region 1310, the first inner coil 1312 undergoes an elastic torsional deflection around the coil axis A_{C}. The first inner coil 1312 is configured to transfer the torsional deflection (and the resulting torsional force around the coil axis A_{C}) along the coil axis A_{C} of the spring body 1302 from the first inner coil 1312 to the first outer coil 1314 along to at least one of the intermediate coils 1322, extending the intermediate spring region 1320 and resulting in a biasing force urging the retention member 1500 (and at least one of the third lens cell 300 or the fourth lens cell 400) toward the flange body 802.

During use, in the second spring end region 1330, when the extension spring 1300 undergoes extension, the second outer coil 1334 undergoes an elastic torsional deflection around the coil axis A_{C}. The second outer coil 1334 is configured to transfer the torsional deflection (and the resulting torsional force around the coil axis A_{C}) along the coil axis of the spring body 1302 from the second outer coil 1334 to the second inner coil 1332 along to at least one of the intermediate coils 1322, extending the intermediate spring region 1320 and resulting in a biasing force urging the retention member 1500 toward the flange body 802.

In another embodiment, though not shown, one of the first spring end region 1310 or the second spring end region 1330 may be replaced by a loop or hook spring termination design known in the art, as described above.

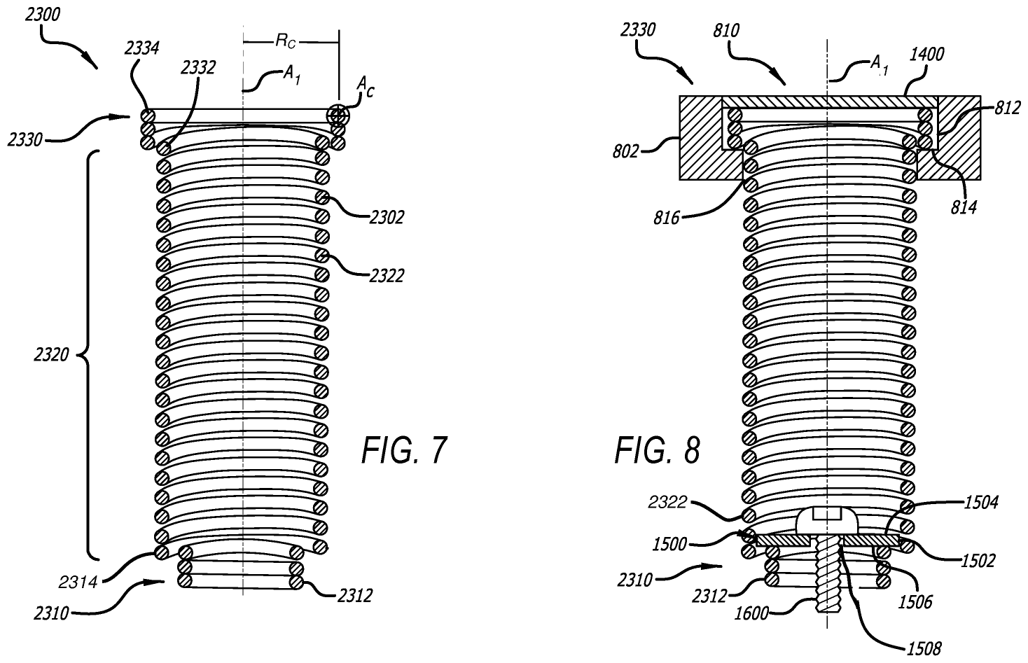

FIGS. 7 and 8 show views of an alternate embodiment of an extension spring 2300 configured for use with the zoom lens assembly 10. As shown, the extension spring 2300 includes a first spring end region 2310, an intermediate spring region 2320, and a second spring end region 2330. In this embodiment, the spring 2300 includes a spring body 2302 having a coil axis A_{C}, wound around a spring axis A₁. The first spring end region 2310 includes a plurality of first inner coils 2312 and a first outer coil 2314 formed in the spring body 2302, with the first inner coil 2312 wound with a coil radius R_{C} smaller with respect to the spring axis A₁ than the coil radius R_{C} of the first outer coil 2314. In the illustrated embodiment, the intermediate spring region 2320 includes a plurality of intermediate coils 2322 formed on the spring body 2302 and wound helically around the spring axis A₁, the intermediate spring region 2320 extending from the first spring end region 2310 to the second spring end region 2330. The second spring end region 2330 includes at least one second inner coil 2332 and a plurality of second outer coils 2334 formed in the spring body 2302. In this embodiment, the second outer coils 2334 has a larger coil radius R_{C} than the intermediate coils 2322 and the second inner coil 2332. The spring body 2302 may be formed from any of the variety of materials as described above with respect to the spring body 1302.

In the illustrated embodiment, the spring body 2302 transitions from the first spring end region 2310 to the intermediate spring region 2320. In this transition, the coil radius R_{C} of the spring body 2302 increases as it transitions along the coil axis A_{C} from the first inner coils 2312 to the first outer coil 2314 and to the intermediate coils 2322 in the intermediate spring region 2320. In one embodiment, at least one of the first inner coils 2312 and the first outer coil 2314 are arranged substantially coplanar. In another embodiment, at least one of the first inner coils 2312 and the first outer coil 2314 are not arranged substantially coplanar. Optionally, at least a portion of the one of the first inner coils 2312 and at least a portion the first outer coil 2314 are arranged coplanar or approximately coplanar.

In the illustrated embodiment, the spring body 2302 transitions from the intermediate spring region 2320 to the second spring end region 2330. In this transition, the coil radius R_{C} of the spring body 2302 increases as the spring body 2302 transitions along the coil axis A_{C} from an intermediate coil 2322 to the second inner coil 2332. The spring body 2302 then transitions from the second inner coil 2332 to a plurality of second outer coils 2334. In one embodiment, at least one of the first inner coils 2312 and the first outer coil 2314 are arranged substantially coplanar. In another embodiment, at least one of the first inner coils 2312 and the first outer coil 2314 are not arranged substantially coplanar. Optionally, at least a portion of one of the first inner coils 2312 and at least a portion the first outer coil 2314 are arranged coplanar or approximately coplanar.

Referring to FIG. 8, when the extension spring 2300 is installed into a structure (e.g., such as the flange 800 of the zoom lens assembly 10), the first spring end region 2310 may be securely retained in a spring recess formed in one of the lens cell bodies (e.g., such as the spring recess 404 formed in the fourth lens cell body 402 as shown in FIG. 4). In one embodiment, at least one retention member 1500 may be provided that engages the first spring end region 2310, the retention member 1500 having a retention member body 1502 having a first retention surface 1504 and a second retention surface 1506 with a passage 1508 formed therein, the passage 1508 configured to allow a coupler or fastener 1600 to traverse therethrough. The second retention surface 1506 engages at least one of the first inner coils 2312 to securely retain at least one of the first inner coil 2312 within the spring recess 404 formed in the fourth lens cell body 402 (e.g., as shown in FIG. 4). In an alternate embodiment, no retention member 1500 may be provided, and the coupler or fastener 1600 may engage at least one of the first inner coils 2312 directly, to securely retain at least one of the first inner coils 2312 within the spring recess 404

FIG. 8 also shows a view of a portion of the flange body 802. In this embodiment, as shown, at least one spring support recess 810 configured to accept and retain the second spring end region 2330 therein is formed in the flange body 802. The spring support recess 810 includes at least one inner diameter 812 and at least one support surface 814 configured to engage at least one of the second outer coils 2334 of the second spring end region 2330. When installed in the zoom lens assembly 10, the extension spring 2300 extends through a passage 816 formed in the flange body 802. In the illustrated embodiment, at least one retention member 1400 may be inserted into the spring support recess 810 to retain the second spring end region 1330 within the spring support recess 810. Examples of the retention member 1400 include, without limitation, washers, plugs, snap rings, set screws, and the like or any combination thereof. Optionally, no retention member 1400 may be used.

During use, when the extension spring 2300 undergoes extension, (e.g., when one of the third lens cell 300 or the fourth lens cell 400 undergoes a change in position along the optical axis A_{O} relative to the flange body 802), in the first spring end region 2310, at least one of the first inner coils 2312 undergoes an elastic torsional deflection around the coil axis A_{C}. The first inner coils 2312 are configured to transfer the torsional deflection (and the resulting torsional force around the coil axis A_{C}) along the coil axis A_{C} of the spring body 2302 from at least one of the first inner coils 2312 to the first outer coil 2314 along to at least one of the intermediate coils 2322, extending the intermediate spring region 2320 and resulting in a biasing force urging the retention member 1500 (and at least one of the third lens cell 300 or the fourth lens cell 400) toward the flange body 802.

During use, in the second spring end region 2330, when the extension spring 2300 undergoes extension, at least one of the second outer coils 2334 undergoes an elastic torsional deflection around the coil axis A_{C}. At least one of the second outer coils 2334 is configured to transfer the torsional deflection (and the resulting torsional force around the coil axis A_{C}) along the coil axis of the spring body 2302 from the at least one of the second outer coils 2334 to the second inner coil 2332 along to at least one of the intermediate coils 2322, extending the intermediate spring region 2320 and resulting in a biasing force urging the retention member 1500 toward the flange body 802.

In another embodiment, though not shown, one of the first spring end region 2310 or the second spring end region 2330 may be replaced by a loop or hook spring termination design known in the art, as described above.

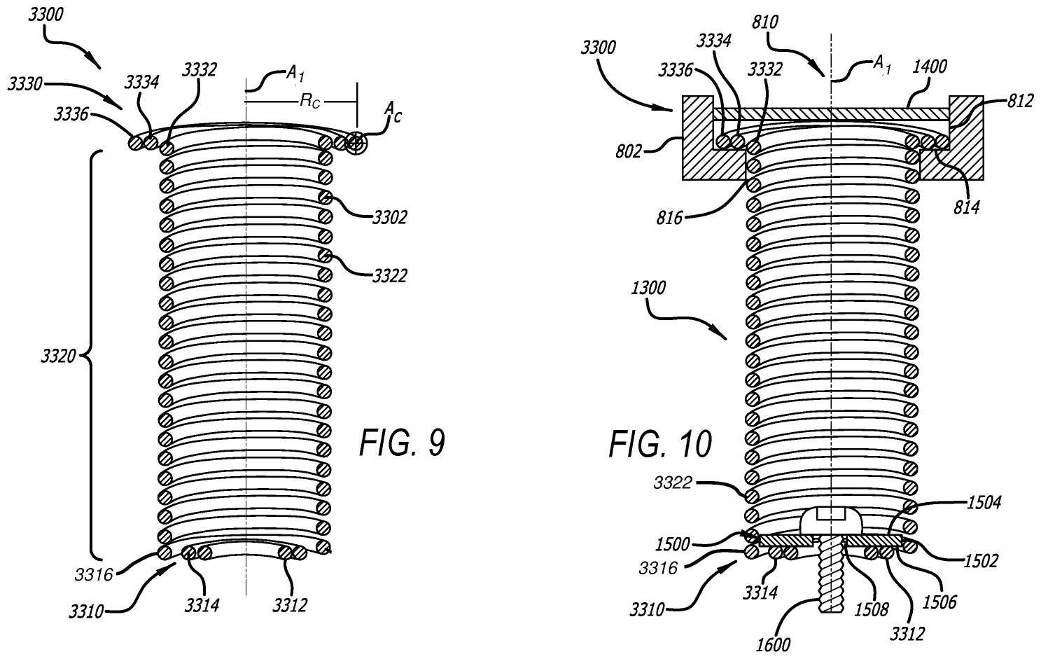

FIGS. 9 and 10 show views of an alternate embodiment of an extension spring 3300 configured for use with the zoom lens assembly 10. As shown, the extension spring 3300 includes a first spring end region 3310, an intermediate spring region 2320, having a plurality of intermediate coils 3322, and a second spring end region 2330. In this embodiment, the spring 3300 includes a spring body 3302 having a coil axis A_{C}, wound around a spring axis A₁. The first spring end region 3310 includes a first inner coil 3312, a second inner coil 3314 and a first outer coil 3316 formed in the spring body 3302, with the first inner coil 3312 wound with a coil radius R_{C} smaller with respect to the spring axis A₁ than the coil radius R_{C} of the second inner coil 3314, the first outer coil 3316, and the intermediate coils 3322. In the illustrated embodiment, the intermediate spring region 3320 includes a plurality of intermediate coils 3322 formed on the spring body 3302 and wound helically around the spring axis A₁, the intermediate spring region 3320 extending from the first spring end region 3310 to the second spring end region 3330. The second spring end region 3330 includes at least one third inner coil 3332, at least one fourth inner coil 3334, and at least one second outer coil 3336 formed in the spring body 3302. In this embodiment, the second outer coil 3336 has a larger coil radius R_{C}than the third inner coil 3332, the fourth inner coil 3334, and the intermediate coils 3322. The spring body 3302 may be formed from any of the variety of materials as described above with respect to the spring body 1302.

In the illustrated embodiment, the spring body 3302 transitions from the first spring end region 3310 to the intermediate spring region 3320. In this transition, the coil radius R_{C} of the spring body 3302 increases as it successively transitions along the coil axis A_{C} from the first inner coil 3312 to the second inner coil 3314, the first outer coil 3316, and to the intermediate coils 3322 in the intermediate spring region 3320. In one embodiment, the first inner coil 3312, the second inner coil 3314, and the first outer coil 3316 are arranged substantially coplanar. In another embodiment, the first inner coil 3312, the second inner coil 3314, and the first outer coil 3316 are not arranged substantially coplanar. Optionally, at least a portion of the first inner coil 3312, at least a portion the second inner coil 3314, and at least a portion of the first outer coil 3316 are arranged coplanar or approximately coplanar.

In the illustrated embodiment, the spring body 3302 transitions from the intermediate spring end region 3320 to the second spring end region 3330. In this transition, the coil radius R_{C} of the spring body 3302 increases as the spring body 3302 radius transitions along the coil axis A_{C} from an intermediate coil 3322 to the third inner coil 3332, to the fourth inner coil 3334, and on to the second outer coil 3336. In one embodiment, the third inner coil 3332, the fourth inner coil 3334, and the second outer coil 3336 are arranged substantially coplanar. In another embodiment, the third inner coil 3332, the fourth inner coil 3334, and the second outer coil 3336 are not arranged substantially coplanar. Optionally, at least a portion of the third inner coil 3332, a portion of the fourth inner coil 3334, and a portion of the second outer coil 3336 are arranged coplanar or approximately coplanar.

Referring to FIG. 10, when the extension spring 3300 is installed into a structure (e.g., such as the flange 800 of the zoom lens assembly 10), the first spring end region 3310 may be securely retained in a spring recess formed in one of the lens cell bodies (e.g., such as the spring recess 404 formed in the fourth lens cell body 402 as shown in FIG. 4). In one embodiment, at least one retention member 1500 may be provided that engages the first spring end region 3310, the retention member 1500 having a retention member body 1502 having a first retention surface 1504 and a second retention surface 1506 with a passage 1508 formed therein, the passage 1508 configured to allow a coupler or fastener 1600 to traverse therethrough. The second retention surface 1506 engages at least one of the first inner coil 3312 or the second inner coil 3314 to securely retain at least one of the first inner coil 3312 or the second inner coil 3314 within the spring recess 404 formed in the fourth lens cell body 402 (e.g., as shown in FIG. 4). In an alternate embodiment, no retention member 1500 may be provided, and the coupler or fastener 1600 may engage at least one of the first inner coil 3312 or the second inner coil 3314 directly, to securely retain at least one of the first inner coils 3312 or the second inner coil 3314 within the spring recess 404.

FIG. 10 also shows a view of a portion of the flange body 802. In this embodiment, as shown, at least one spring support recess 810 configured to accept and retain the second spring end region 3330 therein is formed in the flange body 802. The spring support recess 810 includes at least one inner diameter 812 and at least one support surface 814 configured to engage at least one of the fourth inner coil 3334 and the second outer coil 3336 of the second spring end region 3330. When installed in the zoom lens assembly 10, the extension spring 3300 extends through a passage 816 formed in the flange body 802. In the illustrated embodiment, at least one retention member 1400 may be inserted into the spring support recess 810 to retain the second spring end region 1330 within the spring support recess 810. Examples of the retention member 1400 include, without limitation, washers, plugs, snap rings, set screws, and the like or any combination thereof. Optionally, no retention member 1400 may be used.

During use, when the extension spring 3300 undergoes extension, (e.g., when one of the third lens cell 300 or the fourth lens cell 400 undergoes a change in position along the optical axis A_{O} relative to the flange body 802), in the first spring end region 3310, at least one of the first inner coil 3312 or the second inner coils 3314 undergoes an elastic torsional deflection around the coil axis A_{C}. The first inner coil 3312 and the second inner coil 3314 are configured to transfer the torsional deflection (and a resulting torsional force around the coil axis A_{C}) along the coil axis A_{C} of the spring body 3302 from at least one of the first inner coil 2312 and the second inner coil 3314 to the first outer coil 3316 along to at least one of the intermediate coils 3322, extending the intermediate spring region 3320 and resulting in a biasing force urging the retention member 1500 (and at least one of the third lens cell 300 or the fourth lens cell 400) toward the flange body 802.

During use, in the second spring end region 3330, when the extension spring 3300 undergoes extension, at least one of the second outer coil 3336 or the fourth inner coil 3334 undergoes an elastic torsional deflection around the coil axis A_{C}. At least one of the second outer coil 3336 or the fourth inner coil 3334 is configured to transfer the torsional deflection (and a resulting torsional force around the coil axis A_{C}) along the coil axis of the spring body 3302 from at least one of the second outer coil 3336 or the fourth inner coil 3334 to the third inner coil 3332 along to at least one of the intermediate coils 3322, extending the intermediate spring region 3320 and resulting in a biasing force urging the retention member 1500 (and at least one of the third lens cell 300 or the fourth lens cell 400) toward the flange body 802.

In another embodiment, though not shown, one of the first spring end region 3310 or the second spring end region 3330 may be replaced by a loop or hook spring termination design known in the art, as described above.

The foregoing is illustrative of embodiments and examples of the invention, and is not to be construed as limiting thereof. Although a few specific embodiments and examples have been described with reference to the drawings, those skilled in the art will readily appreciate that many modifications to the disclosed embodiments and examples, as well as other embodiments, are possible without materially departing from the novel teachings and advantages of the invention. Accordingly, all such modifications to the subject matter described herein are intended to be included within the scope of the invention as defined in the claims. For example, skilled persons will appreciate that the subject matter of any sentence, paragraph, example or embodiment can be combined with subject matter of some or all of the other sentences, paragraphs, examples or embodiments, except where such combinations are mutually exclusive. The scope of the present invention should, therefore, be determined by the following claims, with equivalents of the claims to be included therein.

What is claimed is:

1. An extension spring, comprising:
at least one spring body having at least one coil axis;
at least one first spring end region having at least one first inner coil and at least one first outer coil formed on the at least one spring body, wherein:
the at least one coil axis of the at least one spring body transitions from the at least one first inner coil to the at least one first outer coil; and
the at least one first inner coil has at least one coil radius smaller than at least one coil radius of the first outer coil; and
at least one second spring end region having at least one second inner coil and at least one second outer coil formed on the at least one spring body, wherein:
the at least one coil axis of the at least one spring body transitions from the at least one second inner coil to the at least one second outer coil; and
the at least one second inner coil has at least one coil radius smaller than at least one coil radius of the second outer coil; and
at least one intermediate spring region including a plurality of intermediate coils formed on the at least one spring body, the at least one intermediate spring region extending from the at least one first spring end region to the at least one second spring end region.

2. A zoom lens assembly, comprising:
at least one lens support having at least one lens support body and at least one optical axis, the at least one lens support body sized to receive at least one lens cell therein;
at least one extension spring having at least one first spring end region and at least one second spring end region;
at least one structure or flange secured to at least one end of the at least one lens support body, the at least one flange having at least one flange body having at least one spring support recess formed therein, the at least one spring support recess sized to receive at least one of the at least one first spring end region or the at least one second spring end region, the at least one spring support recess further including having at least one support surface formed therein, the at least one support surface configured to support at least one of the at least one first spring end region or the at least one second spring end region;
at least one lens cell having at least one lens cell body having at least one spring recess formed therein, the at least one spring recess sized to receive at least one of the at least one first spring end region or the at least one second spring end region; and
at least one retention member including at least one first retention member body configured to engage and retain at least one of the at least one first spring end region or the at least one second spring end region within the at least one spring recess.

3. An extension spring, comprising:
at least one spring body having at least one coil axis;
at least one first spring end region having one or more first inner coils formed on the at least one spring body;
at least one second spring end region including one or more second outer coils formed on the at least one spring body;
at least one intermediate spring region including a plurality of intermediate coils arranged helically around at least one spring axis and extending from the at least one first spring end region and the at least one second spring end region;
wherein at least one of the one or more first inner coils has a coil radius smaller than the coil radius of at least one of the at least one intermediate coils; and
wherein at least one of the one or more second outer coils has a coil radius larger than the coil radius of at least one of the at least one intermediate coils.

4. The extension spring of claim 3, wherein at least one of the one or more first inner coils is arranged relative to at least one of the plurality of intermediate coils to transfer at least one biasing force from the at least one first spring end region to the at least one intermediate spring region via the at least one first outer coil.

5. The extension spring of claim 3, wherein at least one of the one or more second outer coils is arranged relative to at least one of the plurality of intermediate coils to transfer at least one biasing force from the at least one second spring end region to the at least one intermediate spring region via the at least one second inner coil.

6. The extension spring of claim 3, wherein at least one of the one or more first inner coils is configured to transfer at least one torsional force along the at least one coil axis of the at least one spring body from at least one of the one or more first inner coils to at least one of the plurality of intermediate coils via the at least one first outer coil.

7. The extension spring of claim 3, wherein at least one of the one or more second outer coils is configured to transfer at least one torsional force along the at least one coil axis of the at least one spring body from at least one of the one or more second outer coils to at least one of the plurality of intermediate coils via the at least one second inner coil.

8. The extension spring of claim 3, wherein the at least one first spring end region is configured to interface with at least one first structure, and the at least one second spring end region is configured to interface with at least one second structure, thereby exerting at least one biasing force to urge the at least one first structure toward the at least one second structure.

9. The extension spring of claim 8, wherein the at least one first structure is a lens cell body and the at least one second structure is a flange.

10. A lens assembly, comprising:
at least one lens support body having at least one first end and at least one second end;
at least one optical component coupled to the at least one first end of the at least one lens support body;
at least one flange or structure coupled to the at least one second end of the at least one lens support body, the at least one flange having one or more spring support recesses formed therein;
at least one lens cell having at least one lens cell body with at least one spring recess formed therein; and
one or more extension springs configured to exert at least one biasing force to urge the at least one lens cell toward the at least one flange;
wherein the one or more extension springs comprises:
at least one spring body having at least one coil radius;
at least one first spring end region having one or more first inner coils formed on the at least one spring body;
at least one second spring end region including one or more second outer coils formed on the at least one spring body;
at least one intermediate spring region including a plurality of intermediate coils having at least one coil radius, the intermediate coils arranged helically around at least one spring axis and extending from the at least one first spring end region to the at least one second spring end region;
wherein the one or more first inner coils has at least one coil radius smaller than the at least one coil radius of at least one of the plurality of intermediate coils; and
wherein the one or more second outer coils has at least one coil radius larger than at least one of the at least one coil radius of the plurality of intermediate coil radius.

11. The lens assembly of claim 10, wherein the at least one lens cell is at least one of the at least one second lens cell, the at least one third lens cell, and the at least one fourth lens cell.

12. An extension spring, comprising:
at least one spring body having at least one coil axis;
at least one first spring end region;
at least one second spring end region; and
at least one intermediate spring region including a plurality of intermediate coils formed on the at least one spring body, the at least one intermediate spring region extending from the at least one first spring end region to the at least one second spring end region.

13. The extension spring of claim 12, wherein the at least one first spring end region includes at least one first inner coil and at least one first outer coil formed on the at least one spring body, wherein the at least one coil axis of the at least one spring body transitions from the at least one first inner coil to the at least one first outer coil.

14. The extension spring of claim 12, wherein the at least one second spring end region includes at least one second inner coil and at least one second outer coil formed on the at least one spring body, wherein the at least one coil axis of the at least one spring body transitions from the at least one second inner coil to the at least one second outer coil.
